(19) United States
(12) Patent Application Publication
(10) Pub. No.: US 2011/0070363 A1
(43) Pub. Date: Mar. 24, 2011

(54) PROCESS FOR PRODUCTION OF WATER-RESISTANT ORGANIC THIN FILM

(75) Inventors: Makoto Komatsubara, Osaka (JP); Tomoaki Masuda, Osaka (JP)

(73) Assignee: NITTO DENKO CORPORATION, Ibaraki-shi, Osaka (JP)

(21) Appl. No.: 12/992,723

(22) PCT Filed: Feb. 13, 2009
(86) PCT No.: PCT/JP2009/052368

§ 371 Date: Nov. 15, 2010

(30) Foreign Application Priority Data
Jun. 6, 2008 (JP) 2008-148803

(51) Int. Cl. G02B 1/10

(52) U.S. Cl. 427/163.1

(57) ABSTRACT

There is provided a process for production of a water-resistant organic thin film without causing damage to the water-resistant organic thin film which comprises the steps of: (a) keeping supporting means away from an organic thin film; (b) preventing a base material on which the organic thin film is laminated from warping; and (c) allowing the base material on which the organic thin film is laminated to gently pass through a water-resistant treatment liquid in a reactor.

### BACKGROUND OF THE INVENTION

1. Field of the Invention

The present invention relates to a process for production of a water-resistant organic thin film, more particularly to a process for production of a water-resistant polarizing film.

2. Description of the Related Art

Conventionally, a process for applying a water-resistant treatment liquid onto a surface of an organic thin film laminated on one side of a base material is known as a process for production of a water-resistant organic thin film (Japanese Patent Application Laid-Open Publication No. JP 11-21538 A. However, many of organic thin films before water-resistant treatment are very fragile, so that such organic thin films might peel off or crack when coming into contact with support means such as rolls. Further, there might appear cracks on the organic thin films only by warping the base materials. Furthermore, there is a possibility that the organic thin films might peel off even by the application of shower of a water-resistant treatment liquid. For the aforementioned reasons, it was difficult to continuously perform water-resistant treatment without causing mechanical damage to the organic thin films.

### SUMMARY OF THE INVENTION

In conventional processes for production of water-resistant organic thin films, it was difficult to continuously perform water-resistant treatment without causing mechanical damage to the organic thin films. It is an object of the present invention to provide a process for production of a water-resistant organic thin film without causing mechanical damage to the organic thin film by solving such a problem.

As a result of investigations carried out by the Inventors of the present invention, they have found out that it is possible to continuously perform water-resistant treatment without causing any mechanical damage to organic thin films by following the steps (a) to (c) mentioned below.
(a) keeping supporting means away from an organic thin film (allow the supporting means to be in contact with a base material alone).
(b) feeding a base material on which an organic thin film is laminated without warping.
(c) allowing the base material on which the organic thin film is laminated to gently pass through a water-resistant treatment liquid in a reactor (avoid causing the organic thin film any mechanical shock such as shower).

The summary of the present invention is described as follows:

In a first preferred embodiment, a process for production of a water-resistant organic thin film according to the present invention whereby an organic thin film laminated on one side of a base material in the form of a long film is immersed in a water-resistant treatment liquid in a reactor which comprises the steps of: carrying the base material on which the organic thin film is laminated into the water-resistant treatment liquid from a carrying-in opening of one wall surface of the reactor provided below the liquid level of the water-resistant treatment liquid; performing water-resistant treatment while allowing the base material on which the organic thin film is laminated to pass through the water-resistant treatment liquid; and carrying the base material out on which the organic thin film is laminated from a carrying-out opening of the other wall surface of the reactor provided below the liquid level of the water-resistant treatment liquid, wherein the organic thin film is continuously water-resistant treated while supporting the other side of the base material without an organic thin film.

In a second preferred embodiment of the process for production of a water-resistant organic thin film according to the present invention, the circumference of the carrying-in opening and the carrying-out opening is not in contact with the organic thin film.

In a third preferred embodiment, the process for production of a water-resistant organic thin film according to the present invention further comprises the step of keeping the liquid level of the water-resistant treatment liquid always above the organic thin film by supplying the reactor with an equivalent amount of a decrease in the water-resistant treatment liquid caused by a runoff of the water-resistant treatment liquid from the carrying-in and carrying-out openings.

In a fourth preferred embodiment of the process for production of a water-resistant organic thin film according to the present invention comprises the additional step of receiving the water-resistant treatment liquid flowing out from the carrying-in and carrying-out openings at a reservoir provided below the reactor to return the water-resistant treatment liquid to the reactor from the reservoir.

In a fifth preferred embodiment of the process for production of a water-resistant organic thin film according to the present invention, means for supporting the other side of the base material without an organic thin film is a support roll.

In a sixth preferred embodiment of the process for production of a water-resistant organic thin film according to the present invention, the organic thin film before water-resistant treatment is an organic thin film including a compound containing a —SO₃M group or a —COOM group, in which M is a monovalent cation and the water-resistant treatment liquid is a liquid including a divalent cation or a trivalent cation.

In a seventh preferred embodiment of the process for production of a water-resistant organic thin film according to the present invention, the organic thin film before water-resistant treatment includes a compound represented by the following general formula (1):

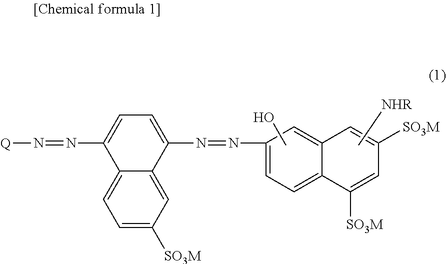

wherein Q is an aryl group which may have a substituent group; R is a hydrogen atom, an alkyl group having 1 to 3 carbon numbers, an acetyl group, a benzoyl group, or a phenyl group which may have a substituent group; and M represents an element to provide a monovalent cation.

In an eighth preferred embodiment of the process for production of a water-resistant organic thin film according to the present invention, the organic thin film before water-resistant treatment includes a compound represented by the following general formula (2):

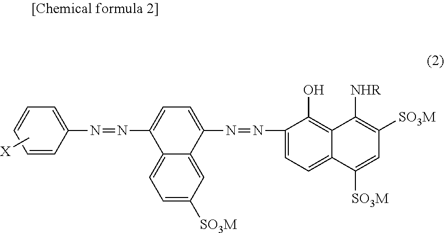

wherein R is a hydrogen atom, an alkyl group having 1 to 3 carbon numbers, an acetyl group, a benzoyl group, or a phenyl group which may have a substituent group; and M represents an element to provide a monovalent cation, X is a hydrogen atom, a halogen atom, a nitro group, a cyano group, an alkyl group having 1 to 4 carbon numbers, an alkoxy group having 1 to 4 carbon numbers, or a —SO₃M group.

### ADVANTAGE OF THE INVENTION

According to the present invention, it is possible to perform water-resistant treatment of an organic thin film without peeling off or cracks of the organic thin film, that is, by a process suitable for a mass production.

### DESCRIPTION OF THE PREFERRED EMBODIMENTS

### Process for Production of Water-Resistant Organic Thin Film

FIG. 1 is a schematic view of one embodiment of a process for production of a water-resistant organic thin film according to the present invention. An organic thin film 12a is continuously water-resistant treated by contacting a water-resistant treatment liquid 14 in a reactor 13 to the organic thin film 12a laminated on one side of a base material 11 in the form of a long film. The present invention includes the following processes A and B.

In process A, the organic thin film 12a that before water-resistant treatment laminated on one side of the base material 11 in the form of a long film is carried in the water-resistant treatment liquid 14 from a carrying-in opening 16 provided on one wall surface of the reactor 13 while supporting the other side (in figure, a lower face) of the base material 11 without an organic thin film. And the carrying-in opening 16 is located below a liquid level 14a of the water-resistant treatment liquid 14. The circumference of the carrying-in opening 16 is in such a size and a shape that is not in contact with the organic thin film 12a.

In the process B, the organic thin film 12a is allowed to pass through the water-resistant treatment liquid 14 so as not to warp the organic thin film 12a laminated on one side of the base material 11 and is water-resistant treated and subsequently, is taken out from a carrying-out opening 17 provided on the other wall surface of the reactor 13. The circumference of the carrying-out opening 17 is in such a size and a shape that is not in contact with the organic thin film 12b that has been water-resistant treated.

According to the processes A and B, the organic thin film is carried in and out from/to a water-resistant treatment bath without being in contact with supporting means and the carrying-in and carrying-out openings. Further, the organic thin film is conveyed without curving in such processes. In this way, it is possible to continuously perform water-resistant treatment without peeling off and cracks of the organic thin film.

It is preferable to convey a laminate formed by laminating an organic thin film on a base material substantially horizontally. Accordingly, the carrying-in opening and the carrying-out opening are provided at the substantially same level.

In addition to the aforementioned processes A and B, the production process of the present invention preferably includes the following processes C and D.

In process C, as shown in FIG. 2, the liquid level 14a of the water-resistant treatment liquid 14 is always kept above the organic thin film 12a by supplying the reactor 13 with an equivalent amount of a water-resistant treatment liquid 18 for flowing out from the carrying-in opening 16 and carrying-out opening 17. This makes the whole organic thin film 12a in the reactor 13 go into a state of always being immersed in the water-resistant treatment liquid 14, so that it is possible to avoid such a situation that part of the organic thin film 12a is exposed from the water-resistant treatment liquid 14.

In process D, as shown in FIG. 3, the water-resistant treatment liquid 18 for flowing out from the carrying-in opening 16 and the carrying-out opening 17 is stored in a reservoir 19 provided below the reactor 13 and is supplied so as to return to the reactor 13 from the reservoir 19 with a pump 20 and a piping system 21 to always keep the liquid level 14a of the water-resistant treatment liquid 14 above the organic thin film 12a. This makes it possible to cyclically use the water-resistant treatment liquid 14, resulting in a reduction of the production cost.

### [Organic Thin Film Before Water-Resistant Treatment]

To avoid contact with the supporting means (typically, a support roll), the organic thin film before water resistant-treatment is laminated on one side of the base material in the form of a long film. The base material is not particularly limited, but may be a film formed of any material, such as nornornene-based resins, cellulose-based resins, and ester-based resins or the like. The base material typically has a width of 100 to 3,000 mm and a length of 50 to 5,000 m, and a thickness of 5 to 100 μm.

The organic thin film preferably includes a compound containing a —SO₃M group or a —COOM group, in which M represents a monovalent cation. Although such a compound is superior in solubility in a hydrophilic solvent, the compound may be poor in durability in a high humidity environment. The organic thin film of the present invention, however, comes to exhibit superior durability by being water-resistant treated.

The organic thin film before water-resistant treatment preferably includes an azo compound represented by the general formula (1) mentioned below. In the general formula (1), Q represents an aryl group which may have a substituent group. R is a hydrogen atom, an alkyl group having 1 to 3 carbon numbers, an acetyl group, a benzoyl group, or a phenyl group which may have any substituent group; M represents an atom to provide a monovalent cation, preferably a hydrogen atom or an alkali metal atom. The organic thin film before water-resistant treatment includes an azo compound represented by the general formula (1) preferably at 70 to 100 weight % out of the total weight of the organic thin film.

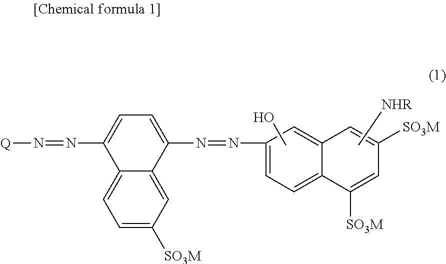

In such an azo compound, even when a monovalent cation (M) is exchanged for a divalent cation having a large ionic radius, the linearity of the molecular structure is presumed to be maintained because sulfonic ions are spaced at moderate intervals. This allows the orientation degree (dichroic ratio, degree of polarization) of the water-resistant organic thin film to remain unchanged before and after the water-resistant treatment when the water-resistant organic thin film is a polarizing film.

In the general formula (1), the substitution position of a hydroxyl group (—OH) and an amino group (—NHR) is not particularly limited, but may be substituted for any position of a naphthalene backbone.

The organic thin film before water-resistant treatment more preferably includes an azo compound represented by the following general formula (2). In the general formula (2), R and M are the same as those in the general formula (1). X is a hydrogen atom, a halogen atom, a nitro group, a cyano croup, an alkyl group having 1 to 4 carbon numbers, an alkoxy group having 1 to 4 carbon numbers, or a —SO₃M group (M represents an atom to provide a monovalent cation). The use of such azo compound makes it possible to obtain a polarizing film (water-resistant polarizing film) having a high dichoric ratio.

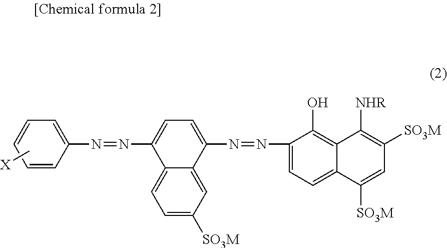

It is possible to obtain the azo compound represented by the general formulae (1) and (2) by diazotizing and coupling an aromatic compound having an amino acid (e.g., an aniline derivative and an amino naphthalene derivative) and a naphthalene sulfonic acid derivative in accordance with a conventional method and the obtained monoazo compound is subject to diazotization and coupling reaction with amino naphthalene sulfonic acid derivative.

An example of the aforementioned naphthalene sulfonic acid derivative typically includes 8-amino-2-naphthalene sulfonic acid or the like. And examples of the amino naphthalene sulfonic acid derivative include 1-amino-8-naphthol-2,4-disulfonic acid lithium salt or the like.

The organic thin film before water-resistant treatment may include other compounds in addition to the azo compound represented by the aforementioned general formula (1) or (2). Examples of the other compounds include azo compounds, anthraquinone compounds, perylene compounds, quinophthalone compounds, naphthoquinonic compounds, and merocyanine compounds or the like. These compounds preferably have sulfonic acid groups, carboxylic acid groups or those that respectively have a base.

It is possible to obtain the organic thin film before water-resistant treatment by typically casting a coating solution including an azo compound represented by the general formula (1) or (2) and a solvent. The aforementioned azo compound may be oriented by flowing when applying shearing force in a liquid crystal state. In addition to shearing force, an orientation means may combine base orientation treatment, such as rubbing treatment and optical orientation or the like and orientation by a magnetic field and an electric field. Solvents to be used in the present invention are not particularly limited, but hydrophilic solvents such as water, alcohol kinds, cellosolve kinds are preferably used as solvents.

### [Supporting Means]

The supporting means to be used in the present invention is not particularly limited as long as the supporting means may support the base material side in the form of a long film on which an organic thin film is laminated on one side thereof. The supporting means is typically a support roll. The support roll may support the base material and perform a feeding drive.

The base material on which the organic thin film before water-resistant treatment is laminated is preferably fed horizontally. There is a possibility that the organic thin film may be peeled off or cracked when the base material on which the organic thin film before water-resistant treatment is laminated warps.

The feeding rate of the base material on which the organic thin film is laminated is preferably 5 m/minute to 200 m/minute.

### [Reactor]

The reactor to be used in the present invention is not particularly limited as long as the reactor can store a certain amount of the water-resistant treatment liquid. The reactor typically has a volume of 50 cm³ to 50 m³. The depth of the reactor is typically 5 mm to 50 cm. The shape of the reactor may be a square-shaped box or in a cylindrical shape.

A carrying-in opening for carrying in the base material on which the organic thin film before water-resistant treatment is laminated is provided on one wall surface of the reactor. And the carry-in opening is provided below the liquid level of the water-resistant treatment liquid. Further, a carrying-out opening for carrying the base material out, on which the organic thin film that has been water-resistant treated is laminated, is provided on the other wall surface of the reactor.

In a preferred embodiment, as shown in FIG. 3, since the reservoir 19 is provided below the reactor 13, it is possible to receive the water-resistant treatment liquid 18 flowing out from the carrying-in opening 16 and carrying-out opening 17. The reactor 13 and the reservoir 19 are preferably connected to each other by the pump 20 and the piping system 21 so as to return the water-resistant treatment liquid 14 to the reactor 13 from the reservoir 19 to be circulated.

### [Water-Resistant Treatment]

In the water-resistant treatment to be performed in the present invention, M of the —SO₃M group or the —COOM group, which represents a monovalent cation, is substituted for a divalent cation or a trivalent cation by bringing the organic thin film including a compound containing the —SO₃M group or the —COOM group into contact with a water-resistant treatment liquid (a liquid including a divalent cation or a trivalent cation). This treatment connects two compounds or more together by an ionic bond, which leads to improve water-resistant properties.

Examples of a divalent cation or a trivalent cation contained in the water-resistant treatment liquid include, for instance, an alkaline-earth metal ion or a metal ion, such as Ni²⁺, Fe³⁺, Cu²⁺, Zn²⁺, Al³⁺, Pd²⁺, cd²⁺, Sn²⁺, Co²⁺, Mn²⁺ or Ce³⁺ and the like. The aforementioned divalent cation or trivalent cation may be used as one kind and may be used in combination of two kinds or more. The water-resistant treatment liquid is typically an aqueous chloride solution (e.g., barium chloride solution, lead chloride solution) to provide a cation thereof.

A chloride to provide the cation included in the water-resistant treatment liquid to be used in the present invention preferably has a concentration of 3 to 50% by weight, more preferably 10 to 40% by weight. There are fears that handling of the chloride may be difficult when the concentration is too high. And there are fears that no sufficient effects may be obtained when the concentration is too low.

The temperature of the water-resistant treatment liquid to be used in the present invention is preferably 15 to 35° C., more preferably 20 to 30° C. When the liquid temperature is too high or too low, there are fears that cracks may occur on the water-resistant polarizing film.

The aforementioned water-resistant treatment liquid is preferably a barium chloride solution. It is easy to industrially obtain a barium chloride solution and the barium chloride solution has significant water-resistant effects.

### [Water-Resistant Organic Thin Film]

The water-resistant organic thin film of the present invention is obtained by performing the aforementioned water-resistant treatment for the organic thin film before water-resistant treatment. The water-resistant organic thin film is more superior in water-resistant properties than the organic thin film before water-resistant treatment in a highly humid environment. The water-resistant organic thin film preferably has a thickness of 0.05 to 2 μm.

The aforementioned water-resistant organic thin film preferably exhibits optical anisotropy and is more preferably a polarizing film exhibiting absorption anisotropy in a visible light region (at wavelength of 380 nm to 780 nm).

In the case where the aforementioned water-resistant organic thin film is a polarizing film, the change rate of the transmittance is preferably 5% or lower, more preferably 3% or lower when the water-resistant organic thin film is stored in a constant temperature and humidity environmental test laboratory at 60° C. and a relative humidity of 90% for 250 hours.

### Example

### Organic Thin Film

In accordance with a conventional method (“Riron Seizo Senryo Kagaku” Fifth Edition (Theoretical production Dye Chemistry), Yutaka Hosoda (published on Jul. 15, 1968, GIHODO SHUPPAN Co., Ltd.), pages 135 to 152), a monoazo compound was produced by diazotizing and coupling 4-nitroaniline and 8-amino-2-naphthalene sulfonic acid. The obtained monoazo compound was diazotized by a conventional method in the same manner and was further subject to diazotization and coupling reaction with 1-amino-8-naphthol-2,4-disulfonate lithium salt to obtain a rough product including an azo compound having the following structural formula (3) and salting out was carried out with lithium chloride to obtain an azo compound having the following structural formula (3):

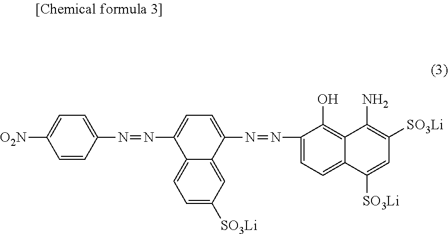

The azo compound of the aforementioned structural formula (3) was dissolved in ion-exchange water to prepare a 20% by weight of a coating solution exhibiting a nematic liquid crystal phase.

The coating solution was cast by flowing on a surface of a long norbornene polymer film (produced by Nippon Zeon Co., Ltd., product name “Zeonor”) with rubbing treatment to obtain an organic thin film laminated on one side of the norbornene polymer film by natural drying.

### [Reactor]

A barium chloride aqueous solution (20% by weight, liquid temperature: 25° C.) was stored in a reactor in which a carrying-in opening and a carrying-out opening were provided at a position which was 2 cm lower than the liquid level of the water-resistant treatment liquid. And then, as shown in FIG. 3, a reservoir 19 for receiving the water-resistant treatment liquid 18 flowing out from the carrying-in opening 16 and the carrying-out opening 17 was provided below the reactor 13 and the reactor 13 was connected to the reservoir 19 by the pump 20 and the piping system 21 to further allow the water-resistant treatment liquid 14 to circulate.

### [Water-Resistant Treatment]

The organic thin film laminated on one side of the aforementioned norbornene-based polymer film was allowed to pass through from the carrying-in opening of the aforementioned reactor to the carrying-out opening of the reactor to be immersed in a water-resistant treatment liquid and was washed in water after being water-resistant treated for 10 seconds to obtain a water-resistant organic thin film with a thickness of 0.4 μm. This water-resistant organic thin film had no mechanical loss such as peeling off or cracks.

This water-resistant organic thin film is a polarizing film exhibiting absorption anisotropy in a visible light region (at a wavelength of 380 to 780 nm). And the degree of polarization of the water-resistant organic thin film by Y value whose visibility had been corrected was 99% and the transmittance was 34.7%.

The aforementioned water-resistant organic thin film and the organic thin film before water-resistant treatment were stored in a constant temperature and humidity environmental test laboratory at 60° C. and a relative humidity of 90% for 250 hours. The change rate of the transmittance of the water-resistant organic thin film was 2.7% and the change rate of the transmittance of the organic thin film before water-resistant treatment was 7.2%.

### [Measuring Method]

### [Measurement of Thickness]

A portion of a polarizing film was released to obtain the thickness of the polarizing film by measuring the level difference using a three-dimensional measurement system of the shape of a non-contact surface (manufactured by Ryoka Systems, Inc., product name: “MM5200”).

### [Observation of Liquid Crystal Phase]

A small amount of a coating solution was sandwiched by two pieces of slide glasses to observe using a polarization microscope (manufactured by OLYMPUS CORPORATION, product name: “OPTIPHOT-POL”) with a large-size sample heating and cooling stage (manufactured by JAPAN HIGH TECH CO., LTD., product name: “10013L”).

### [Measurement of Polarization Degree and Transmittance]

Polarized optical transmission spectrum in a visible light region (at wavelength of 380 to 780 nm) was measured using a spectrophotometer with Glan-Thompson polarizer (manufactured by JASCO Corporation, product name: “V-7100”). Y₁ and Y₂ whose visibility had been corrected from this spectrum were obtained to obtain the polarization degree and the transmittance from the following equation:

polarization degree=(Y₁−Y₂)/(Y₁+Y₂) Equation

transmittance<(Y₁+Y₂)/2 Equation

wherein Y₁ is a transmittance of linear polarization in a maximum transmittance direction and Y₂ is a transmittance of linear polarization in a direction diagonal to the maximum transmittance direction.

### BRIEF DESCRIPTION OF THE DRAWINGS

FIG. 1 is a schematic view showing one embodiment of the present invention;

FIG. 2 is a schematic view showing another embodiment of the present invention;

FIG. 3 is a schematic view showing still another embodiment of the present invention.

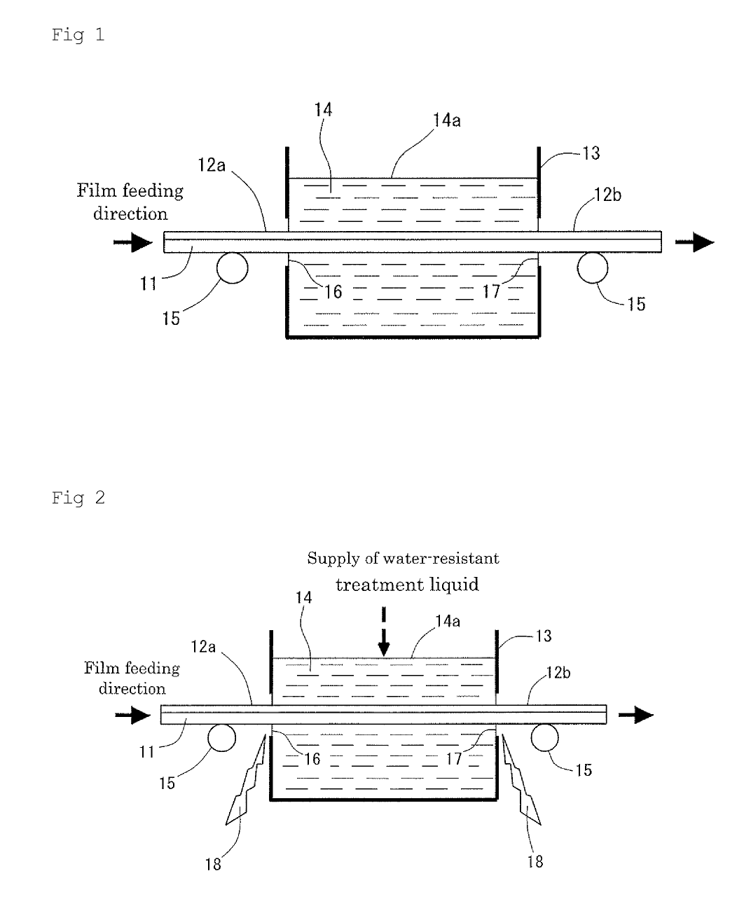

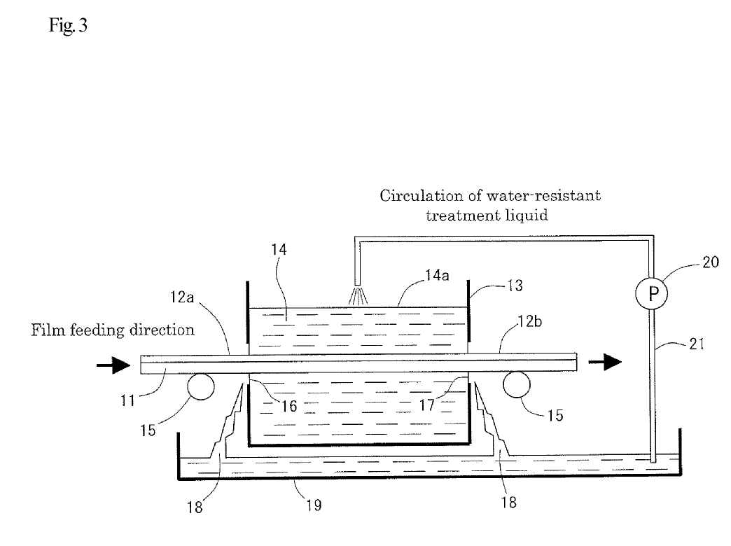

### DESCRIPTION OF THE SYMBOLS

11: base material, 12a: organic thin film, 12b: organic thin film, 13: reactor, 14: water-resistant treatment liquid, 15: supporting means, 16: carrying-in opening, 17: carrying-out opening, 18: water-resistant treatment liquid, 19: reservoir, 20: pump, 21: piping system

What is claimed is:

1. A process for production of a water-resistant organic thin film whereby an organic thin film laminated on one side of a base material in the form of a long film is immersed in a water-resistant treatment liquid in a reactor to be water-resistant treated, comprising the steps of:
carrying the base material on which the organic thin film is laminated into the water-resistant treatment liquid from a carrying-in opening of one wall surface of the reactor provided below the liquid level of the water-resistant treatment liquid;
performing water-resistant treatment while allowing the base material on which the organic thin film is laminated to pass through the water-resistant treatment liquid; and
carrying the base material out on which the organic thin film is laminated from a carrying-out opening of the other wall surface of the reactor provided below the liquid level of the water-resistant treatment liquid,
wherein the organic thin film is continuously water-resistant treated while supporting the other side of the base material without an organic thin film.

2. The process according to claim 1, wherein the circumference of the carrying-in and carrying-out openings is not in contact with the organic thin film.

3. The process according to claim 1 or claim 2, further comprising the step of keeping the liquid level of the water-resistant treatment liquid always above the organic thin film by supplying the reactor with an equivalent amount of a decrease in the water-resistant treatment liquid caused by a runoff of the water-resistant treatment liquid from the carrying-in and carrying-out openings.

4. The process according to claim 3, comprising the additional step of receiving the water-resistant treatment liquid flowing out from the carrying-in and carrying-out openings at a reservoir provided below the reactor to return the water-resistant treatment liquid to the reactor from the reservoir.

5. The process according to claim 1 or claim 2, wherein means for supporting the other side of the base material without an organic thin film is a support roll.

6. The process according to claim 1 or claim 2, wherein the organic thin film before water-resistant treatment is an organic thin film including a compound containing one of a —SO₃M group and a —COOM group, in which M is a monovalent cation and the water-resistant treatment liquid is a liquid including one of a divalent cation and a trivalent cation.

7. The process according to claim 6, wherein the organic thin film before the water-resistant treatment includes a compound represented by the following general formula (1): 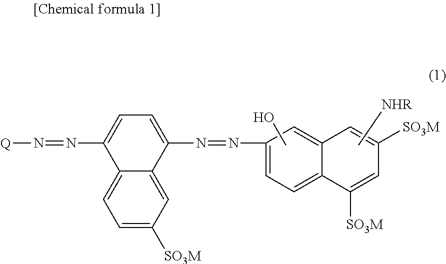
wherein Q is an aryl group which has a substituent group; R is a hydrogen atom, an alkyl group having 1 to 3 carbon numbers, an acetyl group, a benzoyl group, or a phenyl group which has a substituent group; and M represents an element to provide a monovalent cation.

8. The process according to claim 7, wherein the organic thin film before the water-resistant treatment includes a compound represented by the following general formula (2): 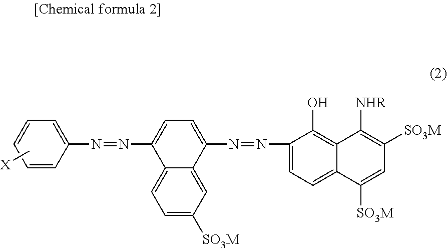
wherein R is a hydrogen atom, an alkyl group having 1 to 3 carbon numbers, an acetyl group, a benzoyl group or a phenyl group which has a substituent group; and M represents an element to provide a monovalent cation, X is a hydrogen atom, a halogen atom, a nitro group, a cyano croup, an alkyl group having 1 to 4 carbon numbers, an alkoxy group having 1 to 4 carbon numbers, or a —SO₃M group.
